(19) United States
(12) Patent Application Publication
(10) Pub. No.: US 2018/0004996 A1
(43) Pub. Date: Jan. 4, 2018

(54) OPTICAL CODE READER

(71) Applicant: SICK AG, Waldkirch (DE)

(72) Inventors: Florian SCHNEIDER, Waldkirch (DE); Christoph ANSELMENT, Waldkirch (DE); Georg SCHÄFER, Waldkirch (DE)

(21) Appl. No.: 15/637,339

(22) Filed: Jun. 29, 2017

(30) Foreign Application Priority Data
Jul. 1, 2016 (DE) 102016112123.1

(51) Int. Cl. G06K 7/10

(52) U.S. Cl. CPC G06K 7/10811

(57) ABSTRACT

An optical code reader (10) is provided that has a light transmitter (12) having a transmission optics (14) for transmitting a reading beam (16) in a reading region (18); a focus adjustment unit (28) for focusing the reading beam (16) in a distance range; a light receiver (24) for generating a received signal from the reading beam (20) reflected in the reading region (18); and an evaluation unit (26) to read code information from the received signal. In this respect, the focus adjustment unit (28) has a pivot arm (30) that holds the transmission optics (14) at a different distance from the light transmitter (12) in dependence on the pivot position of the pivot arm (30) and that has a moving coil unit (34) to pivot the pivot arm (30).

The invention relates to an optical code reader that has a light transmitter having a transmission optics for transmitting a reading beam into a reading region; a focus adjustment unit for focusing the reading beam in a distance range; a light receiver for generating a received signal from the reading beam reflected in the reading region; and an evaluation unit to read code information from the received signal. The invention further relates to a method of reading optical codes in which a reading beam is transmitted by a light transmitter through a transmission optics into a reading region and a received signal is generated in a light receiver from the reading beam received again to read code information from the received signal, wherein the transmission optics is focused by a focus adjustment unit in a distance region.

Optical code readers serve for the detection of the information contained in a code. Barcodes are still particularly widespread, but two-dimensional codes in accordance with various standards are also equally customary. In industrial applications, the code reader is frequently mounted in a stationary manner at a conveyor belt on which objects bearing a code are conveyed past the code reader. On the other hand, handheld devices are also known which are led past codes to be read. There are code scanners that scan the code with a laser beam and camera-based code readers that record an image of the code region and subsequently process it using image evaluation algorithms.

A number of code readers have a focus adjustment to adapt their optics and to detect codes over a required working region. This is usually associated with an autofocus in which the spacing from the object to be recorded is determined and the focal position is adjusted accordingly. In the case of code scanners, it is primarily the transmitted beam that is focused to achieve a sharp, small light spot, while the image shot is focused with the a camera-based code reader.

Some conventional focus adjustments use a stepper motor to vary the distance of the lens. Such stepper motors, however, cause high costs and a large construction volume. An alternative known actuator mechanism is a moving coil. Its principle of action is based on the Lorentz force that is exerted on a coil through which current flows in a magnetic field. Such moving coil actuators are suspended at thin bending beams and this results in a high mechanical sensitivity to shock.

EP 1 513 094 B1, EP 1 698 995 B1 and EP 1 698 996 B1 each describe a code reader in which a mirror is arranged on a pivot arm by whose movement the light path between the lens and the reception optics is decreased or increased to set the effective focal position. The transposition of the mirror, however, also effects a positional change of the optical axis so that it is not suitable for use at the transmission side in a code scanner. The reflective optic is also not suitable for all construction shapes.

A moving coil system is presented in EP 1 788 590 A1 that is also suitable for holding an objective in a laser scanner. However, the moving coil unit here acts directly on the optical system. A further system for the displacement of lenses along the optical axis with the aid of moving coils is known from U.S. Pat. No. 4,615,585.

EP 2 112 540 B1 discloses a stationary camera-based code reader having a camera line whose detected image lines are successively assembled to form a total image in the course of a conveying movement. A reception optics is arranged on a rocker that is pivoted in parallel with the image line for focus adjustments. The displacement of the detection region necessarily accompanying the pivoting thereby plays no role since only the individual lines have a certain mutual offset. EP 2 112 540 B1 does not deal with the focusing of a transmitted beam in a code scanner.

It is therefore the object of the invention to achieve an improved focus adjustment in a code reader.

This object is satisfied by an optical code reader and by a method of reading optical codes in accordance with the respective independent claim. The code reader transmits a reading beam and receives it again to generate a corresponding received signal. An evaluation unit reads the code information with the aid of the received signal provided that the reading beam sweeps over a valid code region, in particular by scanning in accordance with the principle of a code scanner. The evaluation therefore in particular also comprises the determination whether the received signal originates from a code region at all, with this also being able to be determined by pre-processing. A focus adjustment unit provides that the reading beam is focused for the distance of the code to be read, usually in the form of an autofocus unit that determines this distance beforehand. The invention now starts from the basic idea of accommodating the transmission optics on a pivot arm and of pivoting this pivot arm with the aid of a corresponding moving coil unit. The pivot arm acts as a lever via which movements of the moving coil unit are transferred to the focus adjustment with the desired gear increase or gear reduction.

The invention has the advantage that a reliable and fast focus adjustment is achieved. The focus adjustment unit has a compact construction size with small module costs and thus allows correspondingly compact and inexpensive code readers. In addition, the code reader having the focus adjustment unit in accordance with the invention has a design that is insensitive to shock since a degree of freedom is only present along the direction of activation due to the pivot lever and its support.

The moving coil unit preferably has a coil fastened to the pivot arm and a fixed-position permanent magnet in whose magnetic field the coil is arranged. Fixed-position means that the permanent magnet is the fixed point for the pivot movement, i.e. is stationary in the code reader. A suitably controlled current flow through the coil generates a Lorentz force to adopt the controlled focal position.

The permanent magnet preferably generates a homogeneous magnetic field. This provides a linear adjustment and a high efficiency of the exerted force.

The permanent magnet preferably has two magnet pairs that are arranged conversely to one another. The current direction can thereby run conversely in the upper and lower parts of the coil and the coil can thus dip fully into the magnetic field and experience a uniform force direction in so doing.

The pivot arm is preferably supported and is arranged in the moving coil unit such that the pivot movement takes place perpendicular to the longitudinal extent of the pivot arm. In this respect, a coil attached to the pivot arm is in particular arranged in the magnetic field such that a perpendicular pivot movement is effected and thus a particularly effective perpendicular pivot movement for the focus adjustment.

The moving coil unit is preferably arranged at an end of the pivot arm. The force for the pivot movement is thus exerted from the end of the lever arm.

The pivot arm is preferably supported at its one end. If the coil is preferably also located at an end of the lever arm, the end for the support is naturally the other end. The pivot point of the of the pivot movement is located in the support. The transmission optics is then preferably located between the end moved by the moving coil unit and the end of the pivot arm fixed in the pivot point or support point.

The pivot arm is preferably supported by means of a leaf spring. Such a leaf spring is low-cost and stable and it can easily absorb the pivot movement. In this respect, the leaf spring is only flexible in one axis, unlike than with bending beams having a plurality of degrees of freedom otherwise customary for moving coils. This provides flexibility exactly where it is needed and thus provides robustness against mechanical strains such as shock.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

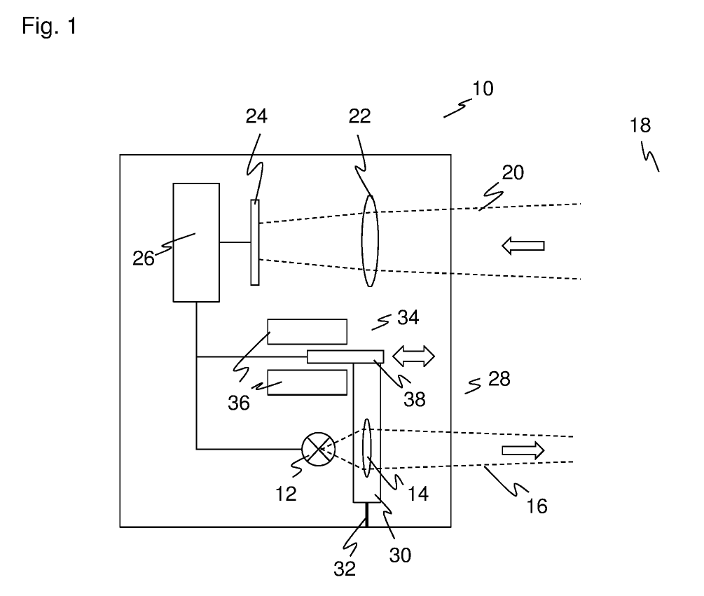

FIG. 1 a simplified block diagram of a code reader with a focus adjustment that has a pivot arm and a moving coil unit;

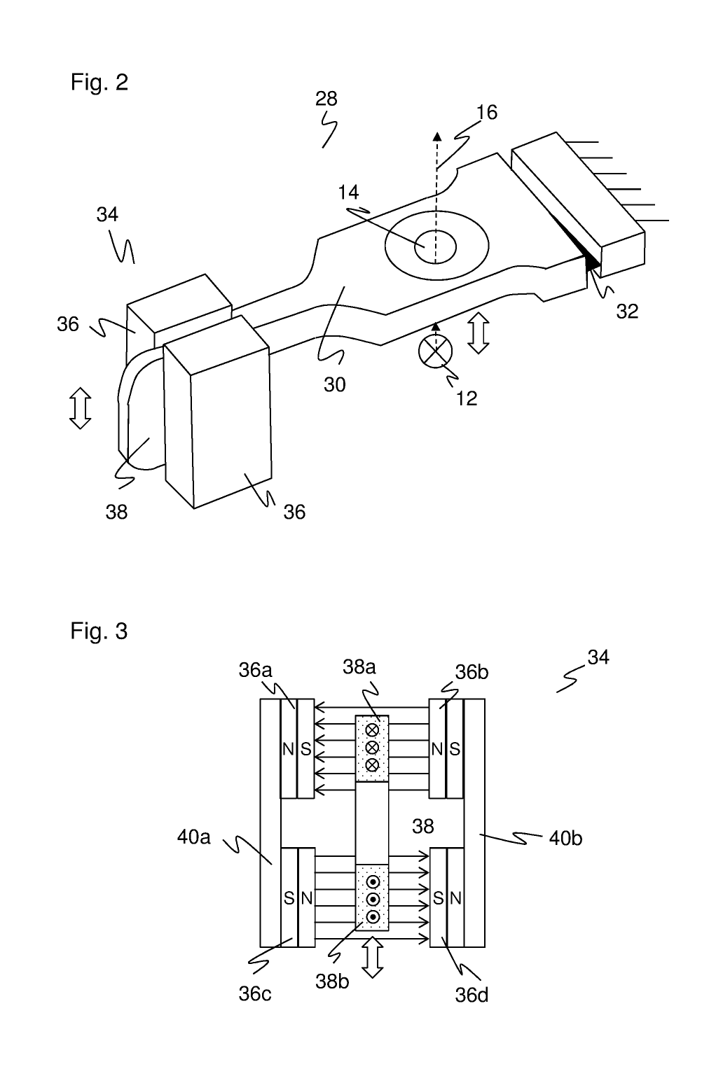

FIG. 2 a three-dimensional view of an embodiment of a focus adjustment unit with a pivot arm and a moving coil unit; and

FIG. 3 a representation of a moving coil unit with a permanent magnet and its magnetic field as well as a live coil immersed therein.

FIG. 1 shows a simplified block diagram of a code reader 10. A light transmitter 12, for example having an LED or a laser as the light source, generates via a transmission optics 14, for example in the form of a lens, a reading beam 16 that is transmitted into a reading region 18. If the reading beam 16 is incident on an object there, the reflected or remitted reading beam 20 returns to the code reader 10 and is conducted to a light receiver 24 via a reception optics 22. A received signal is generated from the incident light of the remitted reading beam 20 there and is supplied to an evaluation unit 26. The evaluation unit 26 is also connected to the light transmitter 12 for its control.

To detect a code in the reading region 18, a scanning takes place by a scan mechanism, for example using a pivoting or rotating mirror that moves the reading beam 16 over the code region. This scan mechanism is not shown for simplification. If the laser beam 16 scans a barcode, for example, the amplitude of the received signal is modulated in a manner corresponding to the code bar. The evaluation unit 26 is therefore able to read the code information. It also recognizes when the received signal does not correspond to any code. The location of code regions and the reading of the code information is known per se and will therefore not be explained in more detail.

It is required for a reliable detection of the code information that the code is at a spacing from the code reader 10 that lies within the depth of field range of the transmitting optics 14. In other words, the light spot generated on the code by the reading beam 16 should be sufficiently focused. To ensure this over a larger distance range, a focus adjustment unit 28 is provided that is likewise connected to the evaluation unit. Although it is conceivable to use the focus adjustment unit 28 for a setting to a fixed or parameterized distance, the respective current distance from an object or code scanned by the reading beam 16 is preferably measured. This can be done by an additional distance measuring unit, not shown.

The laser beam 16 itself, however, is preferably used for a distance measurement in that, for example, a frequency is imparted onto the laser beam 16 by amplitude modulation and the distance is determined in a phase method from the phase offset between the transmission time and the reception time.

The focus adjustment unit 28 is shown schematically in FIG. 1 and again in a preferred embodiment in a three-dimensional view in accordance with FIG. 2. The same reference numerals respectively designate the same features or mutually corresponding features.

The focus adjustment unit 28 has a pivot arm 30 that holds the transmission optics 14 and that is supported at one end at the code reader 10 via a leaf spring 32, for example. Movements of the pivot arm 30 with respect to the leaf spring 32 forming a support point or pivot point therefore provide a difference distance between the transmission optics 14 and the light transmitter 12 and thus a focus adjustment. Such a movement is effected by a moving coil unit 34 that has a permanent magnet 36 in a fixed position with respect to the code reader 10 and has a coil 38 through which current flows, which dips into its magnetic field and which is attached to an end of the pivot arm disposed opposite the leaf spring 32.

The respective degree of the pivot movement or deflection of the pivot arm 30 can be controlled by the evaluation unit 26 by a current flow through the coil 38. A focus table is, for example, stored for this purpose that links the required controls to measured distances or focal positions to be set that are fixed in another manner. The transmission ratio between movements at the moving coil unit 34 and movements of the transmission optics 14 is known and is fixed by the geometry of the pivot arm 30, of the arrangement of the transmission optics on the pivot arm 30 and of the support of the pivot arm 30, that is the pivot point at the leaf spring 32 here and the point of engagement of the adjustment force at the coil 38. The focal resolution can thereby be set.

The focus adjustment explained at the transmission side in a code scanner can in principle also be used at the reception side or in a camera-based code reader instead of in a code scanner.

FIG. 3 again shows the moving coil unit 34 with a magnetic field indicated by arrows and the coil 38 immersed therein. The permanent magnet 36 preferably has two magnet pairs 36a-b and 36c-d that respectively generate a homogeneous magnetic field between them and in which a respective half 38a-b of the coil 38 is located. The upper magnet pair 36a-b and the lower magnet pair 36c-d are oppositely polarized in this respect, with this being simply achievable by a converse arrangement. For the current in the upper half 38a of the coil 38 flows in the converse direction than in the lower half 38b due to the windings and the arrangement. It is achieved by the different polarization of the magnet pairs 36a-b, 36c-d that the Lorentz force is directed the same on both halves 38a-b of the coil 38. Both magnet pairs 36a-b, 36c-d are each connected by a reflux 40a-b to close the magnetic circuit.

1. An optical code reader, the optical code reader comprising:
a light transmitter having a transmission optics for transmitting a reading beam into a reading region;
a focus adjustment unit for focusing the reading beam in a distance range;
a light receiver for generating a received signal from the reading beam reflected in the reading region; and
an evaluation unit to read code information from the received signal, wherein the focus adjustment unit has a pivot arm that holds the transmission optics at a different distance from the light transmitter in dependence on the pivot position of the pivot arm and that has a moving coil unit to pivot the pivot arm.

2. The optical code reader in accordance with claim 1, wherein the moving coil unit has a coil fastened to the pivot arm and a fixed-position permanent magnet in whose magnetic field the coil is arranged.

3. The optical code reader in accordance with claim 2, wherein the permanent magnet generates a homogeneous magnetic field.

4. The optical code reader in accordance with claim 2, wherein the permanent magnet has two magnet pairs that are arranged conversely to one another.

5. The optical code reader in accordance with claim 1, wherein the pivot arm is supported and arranged in the moving coil unit such that the pivot movement takes place perpendicular to the longitudinal extent of the pivot arm.

6. The optical code reader in accordance with claim 1, wherein the moving coil unit is arranged at an end of the pivot arm.

7. The optical code reader in accordance with claim 1, wherein the pivot arm is supported at its one end.

8. The optical code reader in accordance with claim 1, wherein the pivot arm is supported by means of a leaf spring.

9. A method of reading optical codes in which a reading beam is transmitted by a light transmitter through a transmission optics into a reading region and a received signal is generated in a light receiver from the reading beam received again to read code information from the received signal, wherein the transmission optics is focused by a focus adjustment unit in a distance region,
in which method
the focus adjustment of the focus adjustment unit takes place by pivoting a pivot arm that supports the transmission optics and that varies the distance between the light transmitter and the transmission optics; and
the pivot arm is pivoted by a moving coil unit.
